(19) United States
(12) Patent Application Publication
(10) Pub. No.: US 2025/0262465 A1
(43) Pub. Date: Aug. 21, 2025

(54) DEVICE FOR ANCHORING AN OPERATOR TO A HEIGHT WORK STRUCTURE, AS WELL AS AN AERIAL BUCKET COMPRISING SUCH AN ANCHORING DEVICE

(71) Applicant: HAULOTTE GROUP, LORETTE (FR)

(72) Inventors: Clément VIAOUET, LYON (FR); Catherine PERRIER, VILLEURBANNE (FR); David ALVIANI, LYON (FR); Maxime GIRARD, MESSIMY (FR); Emmanuel HUBER, OULLINS (FR)

(21) Appl. No.: 18/857,381

(22) PCT Filed: Apr. 19, 2023
(86) PCT No.: PCT/EP2023/060092

§ 371 Date: Oct. 16, 2024

(30) Foreign Application Priority Data
Apr. 20, 2022 (FR) 2203620

(51) Int. Cl. A62B 35/00; B66F 11/04; E04G 5/00

(52) U.S. Cl. CPC A62B 35/0068; B66F 11/046; E04G 5/001

(57) ABSTRACT

The anchoring device (100) comprises a housing (110), provided with a means (113) of fastening to the height work structure, and a linkage member (120), provided with a fastener (122) which can be hooked by a lanyard (40) to be attached to the operator. The linkage member is movably mounted on the housing along a direction of movement (X120) to move between a retracted configuration. in which the fastener is arranged within an internal volume of the housing to prevent hooking by the lanyard, and an extended configuration in which the fastener is arranged outside the internal volume so that it can be hooked by the lanyard and. once the fastener is hooked by the lanyard. the housing interferes with the lanyard to prevent the linkage member from returning to the retracted configuration. The position of the linkage member in the direction of movement is detected by at least one position sensor (151, 152) arranged in the internal volume.

The present invention relates to a device for anchoring an operator to a height work structure. It also relates to an aerial bucket with such an anchoring device.

The field of the invention is, in general, the safety of operators working at height, in particular operators on board an aerial bucket.

When an operator is working at height, the operator is usually attached by a safety lanyard to the height work structure, such as the platform of an aerial bucket. This way, in case of a fall, the operator remains suspended from the structure. At the operator, one end of the lanyard is typically attached to a harness or vest or safety belt that the operator wears around their body. The opposite end of the lanyard is to be anchored to the height work structure, by means of an anchoring device to which the invention relates.

A rudimentary approach is for the end of the lanyard, typically with a carabiner, to be directly attached to the height work structure. This solution is effective if it is actually hooked on. However, it has been observed that some operators do not hook it on, for the sake of convenience or because they are not aware of the safety rules.

In response to this problem, “intelligent” anchoring devices have been developed in recent years which detect whether a lanyard is attached to them and, if not, issue warning signals or even inhibit certain associated aerial bucket commands. However, these existing anchoring devices are complex and/or impractical, and are thus ill-suited to the generally dirty and demanding working conditions on construction sites. These anchoring devices are also sometimes dependent on one or more specific parts, which makes them very restrictive in use. Furthermore, they are unable to avoid being “fooled” by an unscrupulous operator, for example by allowing a false end to be easily attached, such as the end of a lanyard whose other end is not attached to the operator.

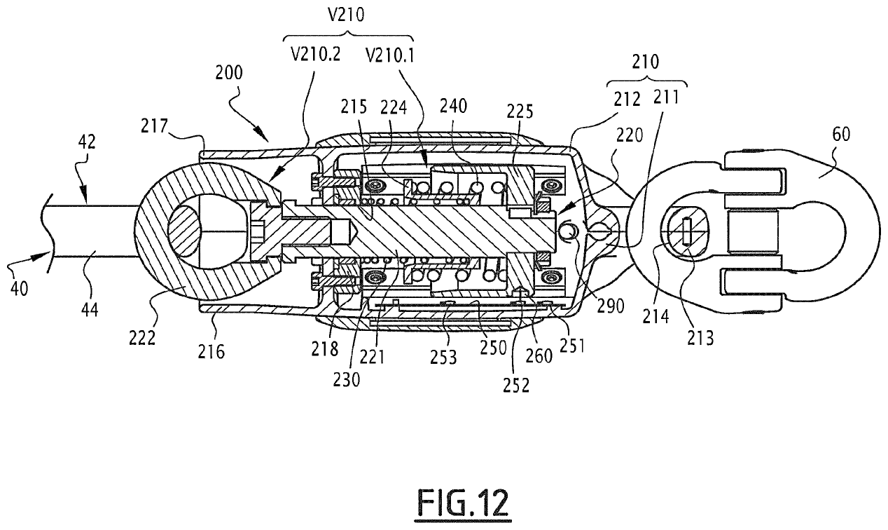

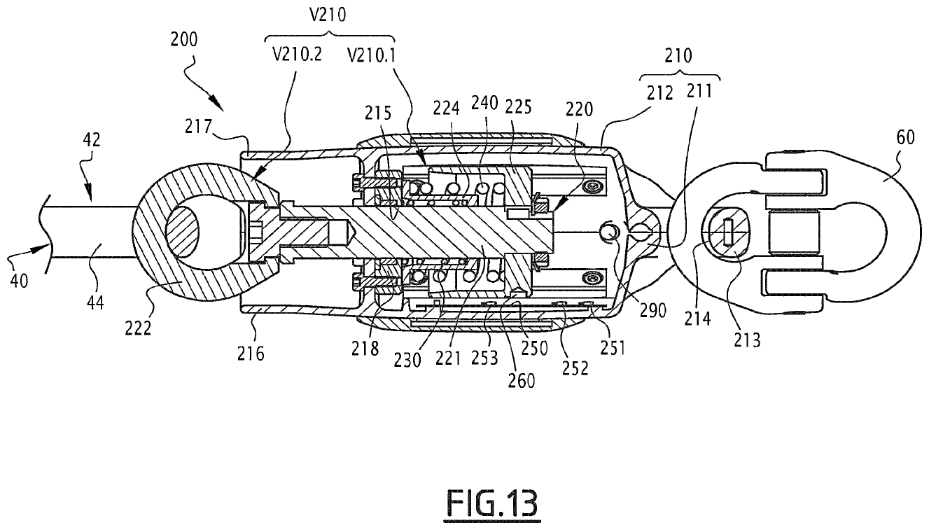

U.S. Pat. No. 9,149,670 B1 discloses an anchoring device for an aerial bucket, comprising an anchoring part which forms a fastener for the carabiner of a lanyard and which, in the embodiment of FIGS. 12 and 13 of U.S. Pat. No. 9,149,670 B1, is provided so as to be vertically movable relative to a fixed housing between two extreme positions, respectively retracted and extended relative to this fixed housing. This anchor acts mechanically, either directly or via a linkage device, on a hydraulic valve that controls the supply of fluid to the hydraulic system of the aerial bucket.

The purpose of the present invention is to provide a new anchoring device which, while being simple and robust, is practical and effective in detecting whether an operator is properly anchored.

To this end, the invention relates to a device for anchoring an operator to a height work structure, such as a platform of an aerial bucket, the anchoring device being as defined in claim 1.

One of the ideas behind the invention is not to seek to directly detect a lanyard that can be hooked to the anchoring device, but to detect, in relation to a housing that can be fixed to the height work structure, the position of a linkage member that can be hooked by the lanyard and that can move between the inside and the outside of the housing in a predetermined direction of movement. The invention provides for the linkage member to move between a retracted and an extended configuration by moving it in the aforementioned direction. In the retracted configuration, the linkage member is so arranged inside the housing that the housing prevents access to a fastener of the linkage member, which is provided for hooking the lanyard. In the extended configuration, the aforementioned fastener is positioned sufficiently outside the housing to make it accessible to be hooked by the lanyard. Once the lanyard is hooked to the fastener in this way, the housing and lanyard mechanically interfere with each other to prevent the linkage from returning to the retracted configuration. In practice, the embodiment of the fastener is not restrictive, nor is that of the end part of the lanyard to be attached to this fastener, so that this end part may in particular take the form of any conventional carabiner. Likewise, the means of the anchoring device according to the invention, by which the housing is attached to the height work structure, is adaptable to any type of structure. In any case, the retracted fastener is not at risk of being damaged or accumulating dirt since it is largely or entirely protected inside the housing. In addition, once the operator has moved the linkage member into the extended configuration and hooked the lanyard to that linkage member, the operator does not have to worry about additional handling of the anchoring device according to the invention, while being assured that the anchoring device is effectively retaining the linkage in the extended configuration as long as the lanyard remains hooked thereto. The invention also provides for the position of the linkage member to be monitored by one or more position sensors: as explained in more detail below, the signal emitted by this or these position sensor(s) is advantageously processed to determine the correct anchoring of the operator, in particular to check that the operator present on the height work structure has actually moves the linkage member into the extended configuration to hook their lanyard thereto and to determine whether the operator has not fallen or whether they are neither inanimate nor attempting to “fool” the anchorage device by attaching a substitute for the lanyard to which the operator is to be attached. Also as will be explained below, the anchoring device in accordance with the invention advantageously makes it possible to emit warning signals in the event of non-anchoring or poor anchoring, and to do so directly to the operator or to personnel in the vicinity of the height work structure, for example in the form of sound or light signals, and/or to a remote data processing system, which uses the corresponding information for various purposes.

It should be noted that the anchoring device in accordance with the invention is applicable to any height work structure, for example to a scaffold.

However, the invention has a preferential application in the field of person lifting machines. The invention further relates to an aerial bucket as defined in claim 16. In practice, this aerial bucket is understood in a broad sense, both in terms of the nature of its lifting structure and its possible capacity for translation on the ground, as explained in detail below.

Additional advantageous features of the anchoring device according to the invention are specified in the other claims.

The invention will be better understood upon reading the following description, given only as an example, and with reference to the drawings, in which:

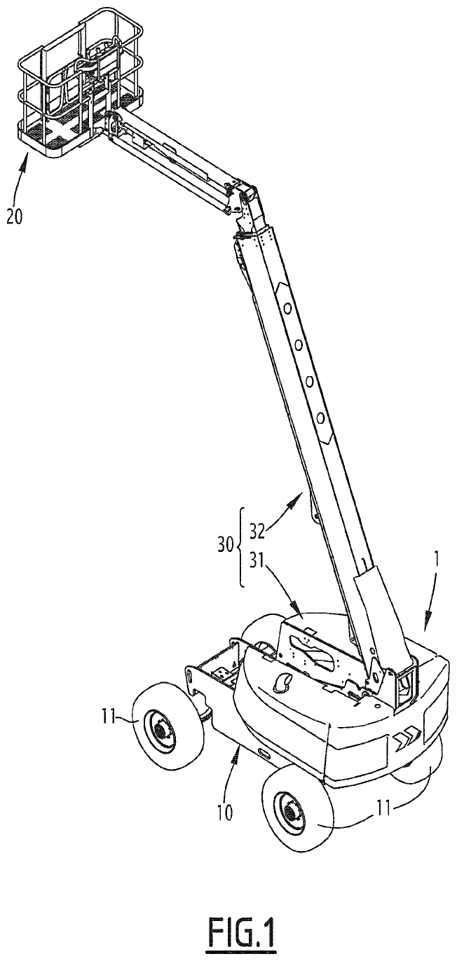

FIG. 1 is a perspective view of a lifting device according to the invention;

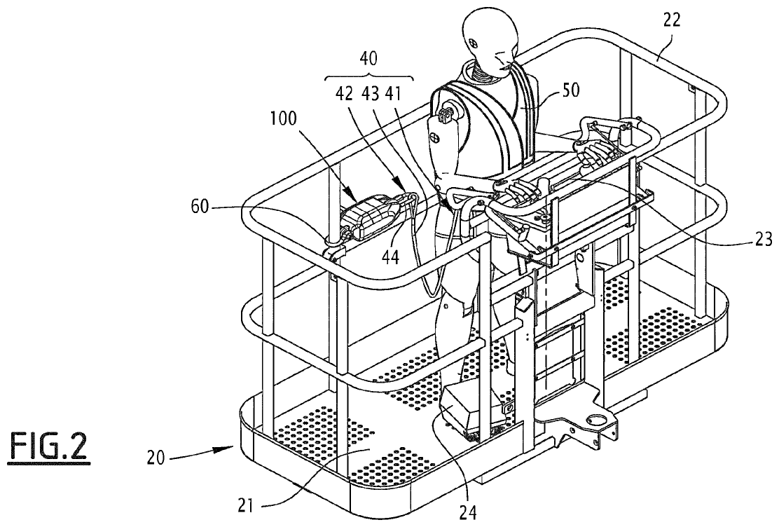

FIG. 2 is an elevation view of a platform of the aerial bucket of FIG. 1, equipped with an anchoring device in accordance with the invention, according to a first embodiment;

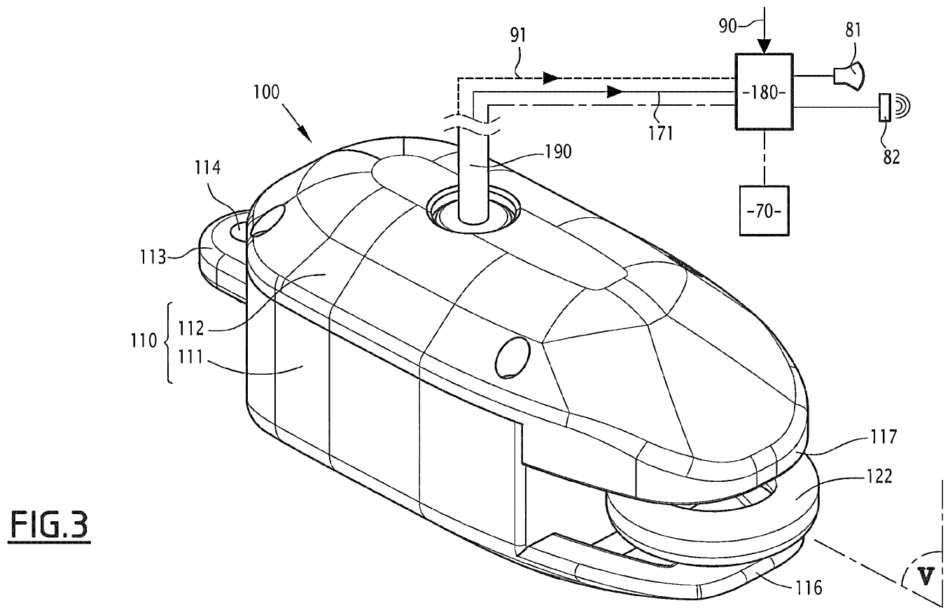

FIG. 3 is a schematic and partially perspective view of the anchoring device of FIG. 2, shown alone;

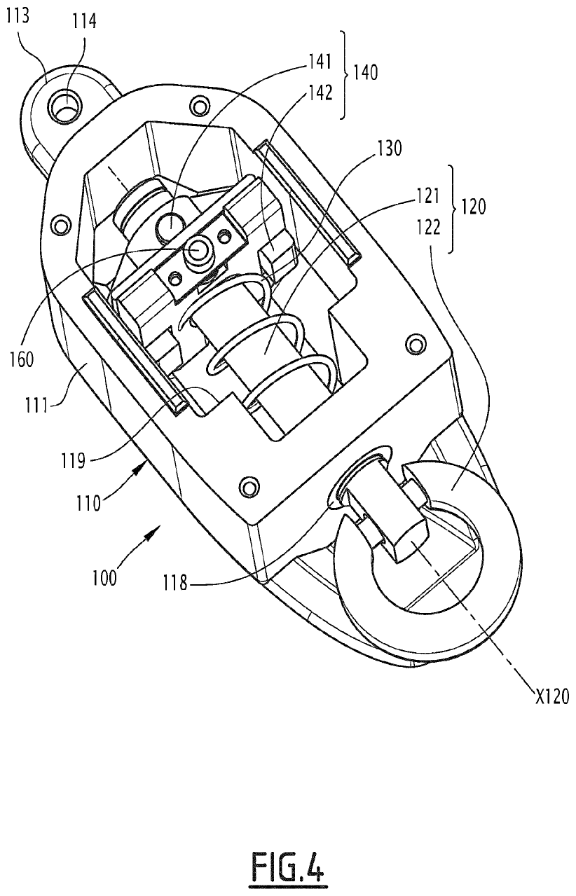

FIG. 4 is an elevation view of only one part of the anchoring device of FIG. 3;

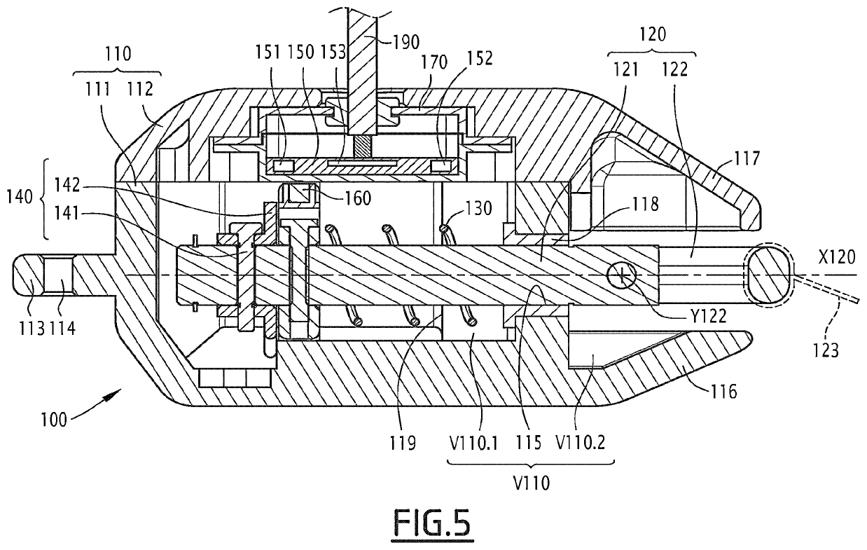

FIG. 5 is a partial view in plane V of FIG. 3,

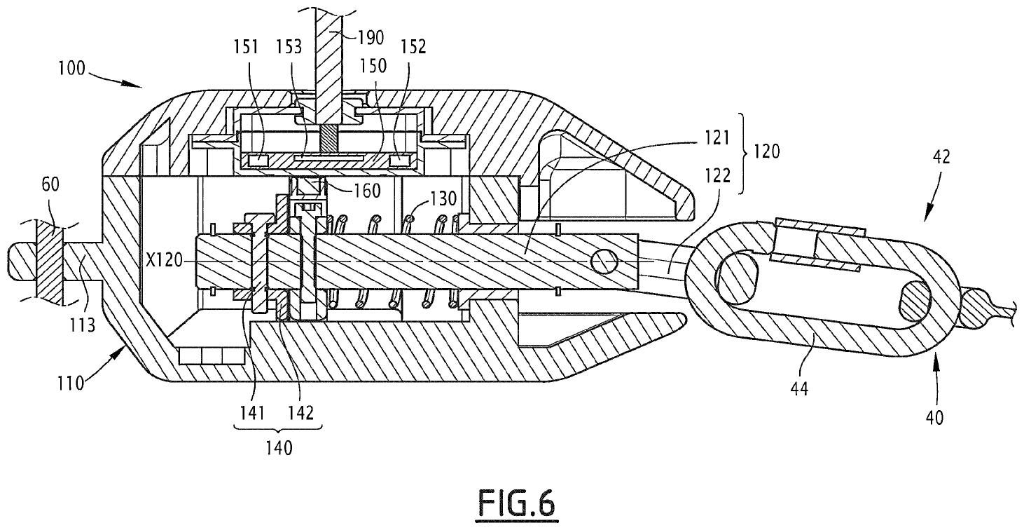

FIGS. 6 to 8 are views similar to FIG. 5, illustrating respectively different states of use of the anchoring device according to the first embodiment;

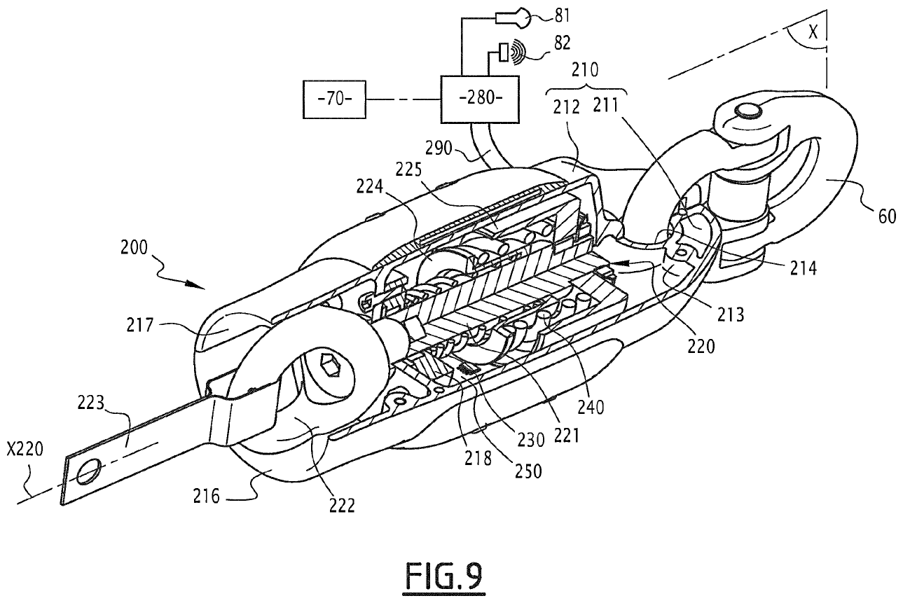

FIG. 9 is a view similar to FIG. 3, illustrating a second embodiment of the anchoring device according to the invention, shown in partial cross-section;

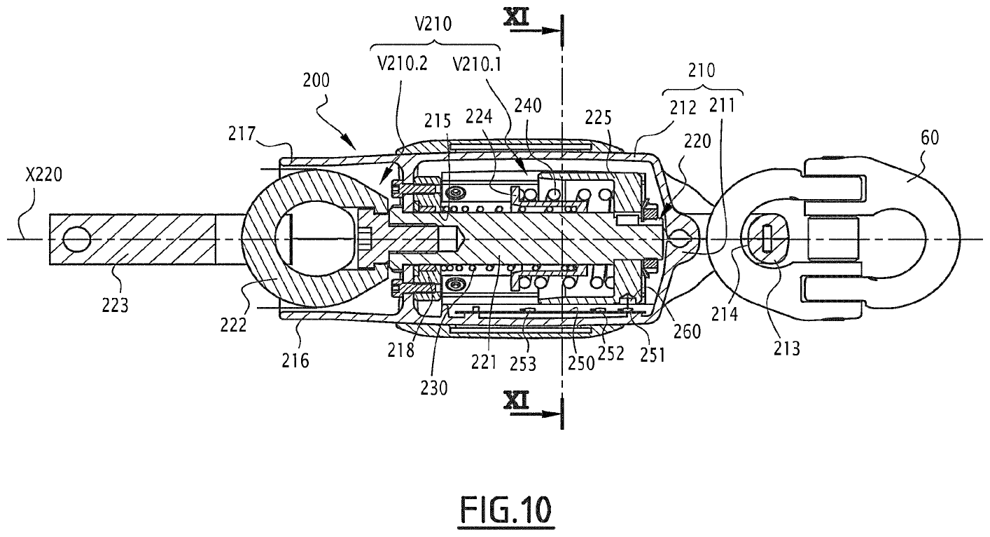

FIG. 10 is a partial cross-section in plane X of FIG. 9,

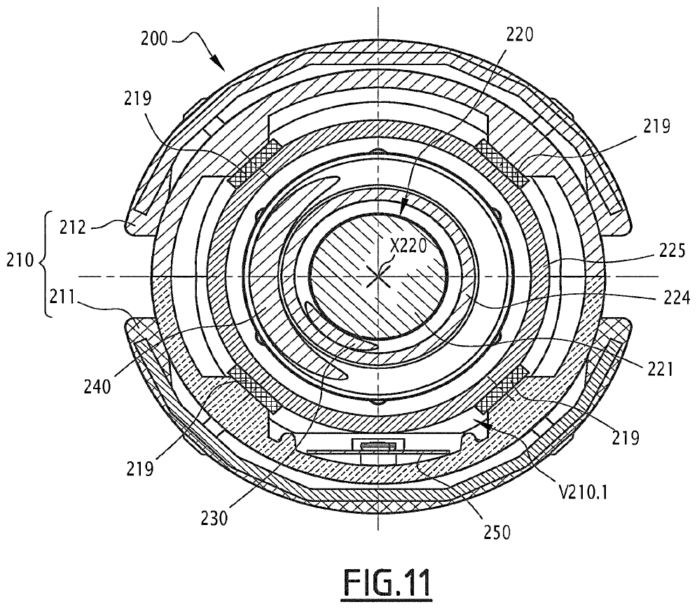

FIG. 11 is a partial cross-section in plane XI-XI of FIG. 10,

FIGS. 12 to 14 are views similar to FIG. 10, respectively illustrating different states of use of the anchoring device according to the second embodiment, these states of use being respectively similar to those of FIGS. 6 to 8.

FIG. 1 shows an aerial bucket 1 that allows one or more operators to reach a high area to carry out work there.

The aerial bucket 1 has a chassis 10 that rests on the ground.

In this example, the chassis 10 rests movably on the ground and is therefore provided with wheels 11 for its translation on the ground. Alternatively, not shown, all or some of the wheels 11 are replaced by tracks. More generally, the wheels 11 are only examples of the ground translation members, which are fitted to the chassis 10. Regardless of the specific features of these ground translation members, the chassis 10 is advantageously designed to be self-propelled so that it can move on the ground by itself. Alternatively, rather than being self-propelled, the aerial bucket 1 is designed to be towed or pushed to move it on the ground.

Alternatively, the chassis 10 rests on the ground in a fixed manner by means of suitable fixed support members.

In any case, the aerial bucket 1 comprises a platform 20, otherwise known as a basket, which is designed for the operator using the platform to stand on. The platform 20 is thus designed to accommodate this operator, as well as, if necessary, one or more other persons and/or equipment, in order to carry out work at height. As shown in more detail in FIG. 2, the platform 20 comprises a floor 21, on which the operator stands and which extends horizontally when the aerial bucket 1 is placed on level ground. The platform 20 also includes a guardrail 22, which rises from the floor 21 surrounding the platform and is intended to prevent people from falling off the platform. Furthermore, the platform 20 is advantageously provided with a control panel 23 allowing the operator on board the platform 20 to control the movement of the chassis 10 on the ground and/or to control the operation of a lifting structure 30 of the aerial bucket 1, supporting the platform 20.

The lifting structure 30 is arranged on the chassis 10 in such a way that the platform 20 can be moved at least in height relative to the frame. To this end, in the example of the design considered in FIG. 1, the lifting structure 30 comprises a turret 31, which rests on the chassis 10 and which is rotatable relative thereto about an axis of rotation extending perpendicularly to the ground, and an arm 32, which connects the turret 31 to the platform 20 and which is deployable so as to move the platform 20 closer to or further from the turret 31, in particular upwards and laterally to the turret. The design of the turret 31 is not limiting. Similarly, the embodiment of the arm 32 is not limiting, it being noted that the term “arm” used here is understood in a broad sense and thus corresponds to an elongated mechanical structure, including several arm elements that are movable relative to each other, in particular in an articulated and/or telescopic manner, for the purpose of deploying this mechanical structure.

More generally, the embodiment of the lifting structure 30 is not limiting as long as, by moving parts of this lifting structure in relation to each other and/or in relation to the chassis 10, the positioning of the platform 20 in relation to the chassis 10 is modified in a corresponding manner, the platform 20 thus being controlled in movement, via the lifting structure 30, by the operator using the aerial bucket 1, in particular from the platform 20 by means of the control panel 23. Thus, in variants not shown, the lifting structure 30 may be without the turret 31 and/or comprise, or even consist of, a scissor lifting mechanism.

Whatever the specific features of the aerial bucket 1, it comprises a safety system, by which the operator on board the platform 20 is attached thereto, and which thus enables the operator to work safely with regard to the risk of falling. As shown schematically in FIG. 2, this safety system comprises a lanyard 40 by which the platform 20 and the operator on board that platform are connected to each other. The lanyard 40 has two ends 41 and 42 which are opposite each other in the longitudinal direction of the lanyard 40. The lanyard 40 also has a rope 43 directly connecting the ends 41 and 42 to each other.

The end 41 of the lanyard 40 is intended to be attached to the operator, typically via a clothing accessory 50 worn by the operator and surrounding the operator's body. The clothing accessory 50 is for example a vest, a harness, a belt or a shoulder strap. In practice, the specifics relating to the end 41 of the lanyard 40 and the clothing accessory 50 are not limiting.

The end 42 of the lanyard 40 is intended to be attached to the platform 20 via an anchoring device 100 which will be described in more detail in relation to FIGS. 3 to 8. According to a practical embodiment, the end 42 of the lanyard 40 comprises a hooking element, such as a conventional carabiner 44, which allows the lanyard 40 to be hooked to the anchoring device 100 and whose embodiment is not restrictive as long as it can mate with the anchoring device 100, as will be explained below.

As can be seen in FIGS. 3 to 5, the anchoring device 100 comprises a housing 110 which, in the example embodiment considered in the Figures, includes a main shell 111 and a cover 112 fixedly attached to the main shell 111. In practice, the housing 110 is advantageously made of a material resistant to shocks and, more generally, to the conditions of use on construction sites, this material being preferably metallic, for example aluminium-based.

The housing 110 is adapted to be attached to the platform 20, in particular to dedicated anchor points of the latter, located for example on the guardrail 22. To this end, the housing 110, in particular its main shell 111, is provided with a fastening means 113, typically mechanical. In the illustrated embodiment, the fastening means 113 has a through-hole 114 for receiving a locking ring 60 that permanently holds the housing 110 onto the platform 20 unless the locking ring 60 is removed and released. The fastening means 113 thus allows the housing 110 to be attached to the platform 20 by an intermediate locking element, such as the locking ring 60 or such as a lifeline along which a ring is freely movable. It is understood that such an intermediate locking element makes the anchoring device 100 adaptable to any embodiment of the platform 20. Alternatively, and not shown, the housing 110 is attached directly to the platform 20, with an adapted form of the fastening means 113 and/or dedicated fittings of the platform 20. In all cases, the fastening means 113 advantageously makes it possible, if necessary in cooperation with the aforementioned intermediate locking element, to retain the housing 110 with respect to the platform 20 in a secure manner, while allowing the positional adjustment of the housing 110 with respect to the platform 20 so that the anchoring device 100 is oriented substantially in the direction in which the stresses exerted by the lanyard 40 on the anchoring device 100 are exerted.

The housing 110 forms an internal volume V110. Here, this internal volume V110 is delimited jointly by the main shell 111 and the cover 112. As can be seen from FIGS. 4 and 5, the internal volume V110 advantageously includes two compartments V110.1 and V110.2, each of which is bounded jointly by the main shell 111 and the cover 112. For reasons that will become apparent later, the housing 110 closes off the compartment V110.1 completely, except for a passage 115 that connects the compartments V110.1 and V110.2 to each other. Furthermore, the housing 110 partially closes the compartment V110.2 and, in the embodiment considered in the figures, includes for this purpose two walls 116 and 117, which belong respectively to the main shell 111 and to the cover 112 and which are arranged opposite each other, delimiting between them the compartment V110.2.

Regardless of the specifics of the housing 110, the anchoring device 100 also comprises a linkage member 120 which participates in mechanical connection between the housing 110 and the lanyard 40. The linkage member 120 is mounted on the housing 110 so as to be movable along a direction of movement X120. In a practical and economical embodiment, which is implemented in the example shown in the figures, the linkage member 120 is movable relative to the housing 110 in translation along a geometric axis which corresponds to the direction of movement X120.

In the embodiment considered in the figures, the linkage member 120 comprises an elongated body 121 which, as clearly visible in FIGS. 4 and 5, extends lengthwise along the direction of movement X120. This elongated body 121 is arranged inside the internal volume V110 of the housing 110, extending both into the compartment V110.1, into the compartment V110.2 and in the passage 115 in which the elongated body 121 is advantageously received in a complementary manner so as to guide the linkage member 120 in movement along the direction of movement X120. To this end, the passage 115 is advantageously delimited by a bearing 118 fixedly integrated onto the housing 110, in particular onto its main shell 111.

Regardless of the design of the elongated body 121, the linkage member 120 also comprises a fastener 122 that can be hooked onto the lanyard 40, more precisely onto the end 42 of this lanyard. Here, the fastener 122 is carried on one of the two opposite longitudinal ends of the elongate body 121.

In a preferred embodiment, the fastener 122 comprises, or even, as shown here, consists of a ring, the inner opening of which forms a hooking zone for the end 42 of the lanyard 40, in particular for the carabiner 44, as illustrated in FIGS. 6 to 8. This ring is advantageously carried by the body 121 in a pivoting manner about a geometric axis Y122 which extends both tangentially to the ring and perpendicularly to the direction of movement X120. This being the case, more generally, the embodiment of the fastener 122 is not limiting since, by means of the movement of the linkage member 120 along the direction of movement X120, the linkage member 120 switches reversibly between:
a retracted configuration, which is shown in FIGS. 3 to 5 and in which the fastener 122 is at least partially, if not totally, arranged inside the internal volume V110 of the housing 110 so that the housing 110 renders the fastener 122 inaccessible to prevent that fastener from being hooked by the lanyard 40, and
an extended configuration, which is shown in FIGS. 2 and 6 to 8 and in which the fastener 122 is at least partially arranged outside the internal volume V110 so that the housing 110 leaves the fastener 122 accessible for hooking by the lanyard 40, in particular by the end 42 of thereof, and, once the fastener 122 is hooked by the lanyard 40, the housing 110 interferes with the lanyard 40 to prevent the linkage member 120 from returning to the retracted configuration.

It is understood that, in both the retracted and extended configurations, the position of the linkage member 120 relative to the housing 110 along the direction of movement X120 is not unique. On the contrary, when the linkage member 120 is in the retracted configuration, this linkage member 120 occupies a position with respect to the housing 110 along the direction of movement X120 from among a continuous set of positions in which the fastener 122 is insufficiently extracted from the internal volume V110 of the housing 110 to allow the lanyard 40, in particular the carabiner 44 of the end 42 of that lanyard, to be hooked to that fastener 122. Likewise, when the linkage member 120 is in the extended configuration, this linkage member occupies a position with respect to the housing 110 along the direction of movement X120 from among a continuous set of positions in which the fastener 122 is sufficiently extracted from the internal volume V110 of the housing 110 to hook the lanyard 40, in particular the carabiner 44 of the end 42 thereof, onto that fastener 122. FIGS. 6, 7 and 8 illustrate three different respective positions of the linkage member 120 in the extended configuration

In the embodiment considered in the figures, the fastener 122 is housed in the compartment V110.2 and is completely covered by the walls 116 and 117 of the housing 110 when the linkage member 120 is in the retracted configuration, as is clearly visible in FIGS. 3 and 5. Thus, when the linkage member 120 is in the retracted configuration, the housing 110 protects the fastener 120, while leaving the fastener 120 free to be extracted from the compartment V110.2 when the linkage member 120 has moved from the retracted configuration to the extended configuration.

Advantageously, the anchoring device 120 comprises a resilient member 130, typically a spring, which acts on the linkage member 120 so as to return that linkage member from the extended configuration to the retracted configuration. In practice, the resilient member 130 is for example interposed, along the direction of movement X120, between the housing 110 and the elongated body 121 so as to be compressed when the linkage member 120 is moved from the retracted configuration to the extended configuration, as is clearly visible by comparing FIG. 5 with FIGS. 6 to 8. In any case, the resilient member 130 tends to move the linkage member 120 into the retracted configuration and to keep it there. In order to move the linkage member 120 from the retracted configuration to the extended configuration, it is necessary to overcome the resistance of the resilient member 130.

To facilitate the manipulation of the linkage member 120 in order to move same from the retracted configuration to the extended configuration, the linkage member 120 is advantageously provided with a gripping element 123 which emerges outside the internal volume V110 when the linkage member is in the retracted configuration. This gripping element 123 is only shown schematically, in dotted lines, in FIG. 5, so as not to encumber the other figures. In practice, this gripping element 123 comprises or consists of a flexible tongue which is permanently attached to the linkage member 120, in particular to its fastener 122. In any case, when the linkage member 120 is in the retracted configuration, the user of the anchoring device 100 can easily take hold of the gripping element 123 and pull thereon to displace the linkage member 120 along the direction of movement X120, until the linkage member is in the extended configuration where the user has access to the fastener 122 in order to hook the lanyard 40 thereto.

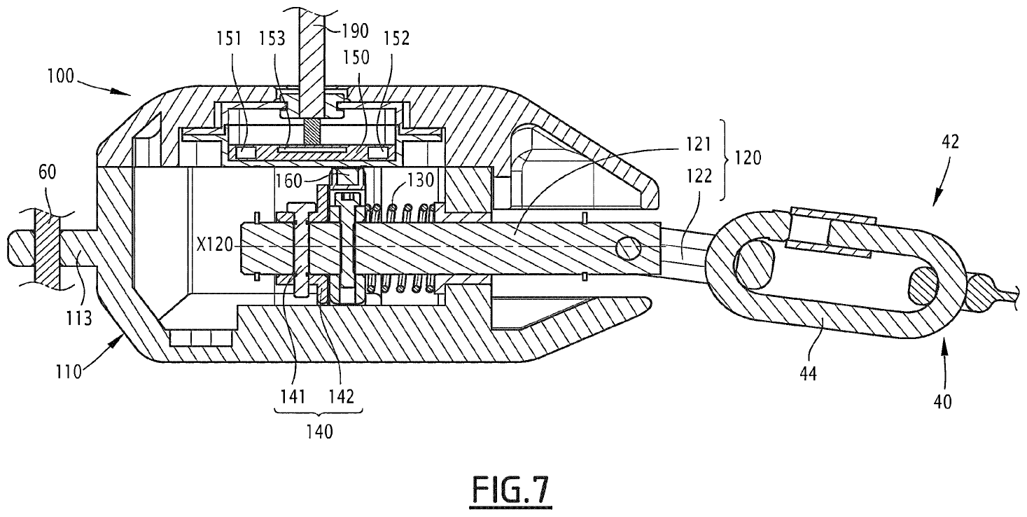

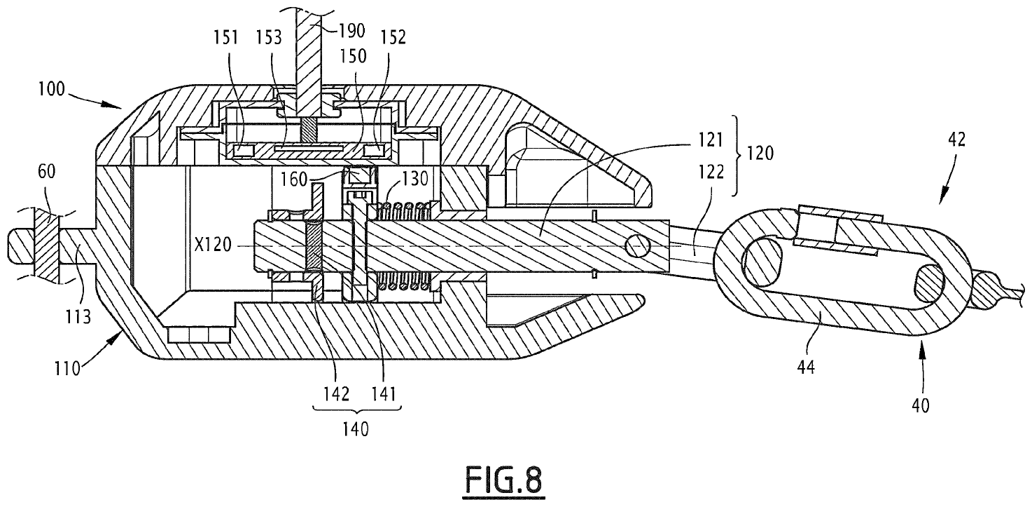

In a particularly advantageous optional arrangement, the linkage member 120 is carried by the housing 110 not directly, but via a mechanism 140 which releasably connects the linkage member 120 and the housing 110. As can be seen from FIGS. 4 and 5, this mechanism 140 here comprises a mechanical fuse 141, the breaking of which causes the mechanism 140 to switch from an unbroken state, shown in FIGS. 2 to 7, to a broken state, shown in FIG. 8. The mechanism 140 also comprises a support 142 which is mounted on the housing 110 so as to be movable along the direction of movement X120, being housed in the internal volume V110, in particular in the compartment V110.1. The support 142 carries the linkage member 120 and is connected to it by the mechanical fuse 141. In the unbroken state of the mechanism 140, the mechanical fuse 141 kinematically connects the linkage member 120 and the support 142 to each other along the direction of movement X120, between two opposite extreme positions between which the linkage member 120 is movable relative to the housing 110 along the direction of movement X120, namely a first functional position, which is illustrated in FIGS. 3 to 5 and which is occupied by the linkage member in the retracted configuration, and a second functional position, illustrated in FIG. 7, which is occupied by the linkage member 120 in an extended configuration and in which the support 142 is brought into abutment along the direction of movement X120 against the housing 110, in particular against an internal shoulder 119 thereof. It is understood that in FIG. 6, the linkage member occupies an intermediate position between the first and second functional positions. In the broken state of the mechanism 140, the linkage member 120 is freely movable along the direction of movement X120 relative to the support 142 so that the linkage member 120 in the extended configuration is movable relative to the housing 110 along the direction of movement X120 between the aforementioned second functional position and a dysfunctional position, which is illustrated in FIG. 8 and which is further from the aforementioned first functional position than the second functional position. In the dysfunctional position, the linkage member 120 is brought into abutment in the direction of movement X120 against the housing 110, in particular against the internal shoulder 119, so as to effectively retain the linkage member 120 relative to the housing 110. The mechanical fuse 141 is designed to break, thereby moving the mechanism 140 from the unbroken state to the broken state, when the linkage member 120 in the second functional position is urged towards the dysfunctional position with a force above a predetermined threshold. This predetermined threshold is, for example, 1000 Newton or, more generally, is chosen between 500 and 2000 Newton. More generally, the predetermined threshold is dimensioned not to be crossed when the anchoring device 100 is manually manipulated by a user for the purpose of reversibly hooking the fastener 122 by the lanyard 40; at the same time, the predetermined threshold is crossed when an operator, attached to the platform 20 via the lanyard 40 and the anchoring device 100, falls from the platform 20 or is subjected to a strong ejection force outward from the platform 20.

The mechanism 140 thus makes it possible, outside of a situation where the operator falls off, to limit the travel of the linkage member 120 with respect to the housing 110 in the direction of travel X120 to the distance between the aforementioned first and second functional positions, while making it possible, when the operator falls off, to cause the linkage member 120 to overtravel with respect to the housing 110, beyond the second functional position, before coming up against the housing 110 and thus being retained thereby.

Of course, other embodiments than the one related to the mechanical fuse 141 and the support 142 are possible for the mechanism 140. In any case, the anchoring device 100 advantageously incorporates a visual indicator to indicate, on the outside of the housing 110, that the mechanism 140 has switched into the broken state and thus that the anchoring device 100 should no longer be used in this state.

In any case, the anchoring device 100 comprises one or more position sensors, which detect(s) the position of the linkage member 120 relative to the housing 110 along the direction of movement X120 and which output(s) a position signal which is representative of this position of the linkage member 120. According to a preferred embodiment, which is both practical and efficient, being adapted to the field of work at construction sites, and which is implemented in the embodiment considered in the figures, two such position sensors are provided, being referred to 151 and 152 in the figures, and each corresponding to a Hall effect sensor. These Hall effect position sensors 151 and 152 are here carried by the same printed circuit board 150 and measure the variation of the magnetic field generated by a permanent magnet 160 which is fixedly carried by the linkage member 120: as is clearly visible by comparing FIGS. 5 to 8, during the movement of the linkage member 120 in the direction of movement X120 with respect to the housing 110, in particular between the first functional position and the aforementioned dysfunctional position, the magnet 160 scans, at a distance, the position sensors 151 and 152, the position of the magnet 160 being more specifically detected by the position sensor 151 when the linkage member 120 is between the aforementioned first and second functional positions, whereas the position of the magnet 160 is more specifically detected by the position sensor 152 when the linkage member 120 is between the aforementioned second functional position and dysfunctional position. However, according to an alternative variant not shown, the Hall effect position sensors 151 and 152 are replaced by a set of mini-switches, which are distributed along the direction of movement X120 and which are scanned in contact by an actuator fixedly carried by the linkage member 120. More generally, the position sensor(s) of the anchoring device 100, such as the Hall effect position sensors 151 and 152, can be embodied in a variety of ways, being active sensors as well as passive sensors, emitting a position signal which can be either analogue or digital, and/or be either contactless or contacting.

Whatever the design of the position sensor(s) 151 and 152, they are arranged inside the internal volume V110 of the housing 110, advantageously being housed in the compartment V110.1. The position sensor(s) 151 and 152 are thus effectively protected by the housing 110. The sealing of the arrangement of the position sensor(s) 151 and 152 inside the housing 110 is advantageously reinforced by any appropriate means. In this regard, in one practical embodiment, which is implemented in the example shown in the figures, the printed circuit board 150 is sealed in a waterproof case 170 which is fixedly carried by the cover 112 of the housing 110.

In order to evaluate the position signal emitted by the position sensor(s) 151 and 152, the anchoring device 100 comprises a processing unit 180 which is connected to the position sensor(s) in such a way that it can process the position signal. In practice, the processing unit 180 is electronic in nature, in the sense that it comprises electronic components, analogue and/or digital, enabling the implementation of the processing steps which will be detailed below.

As illustrated schematically in FIG. 3, the processing unit 180 is preferably dissociated from the housing 110, which, among other things, limits the size of the housing 110 and also has practical and economic advantages. The processing unit 180 is thus connected to the housing 110 by an electrical cable 190, which ensures the transmission of the position signal emitted by the position sensor(s) 151 and 152 and which is here connected to the printed circuit board 150, as schematically indicated by the solid line 171 in FIG. 3. Not shown in detail in FIG. 3, this processing unit 180 is arranged in a dedicated cabinet, which is separate from the housing 110 and which is for example fixedly attached to the platform 20.

Alternatively, and not shown, the processing unit 180 is fully integrated within the housing 110, thus avoiding the need for the aforementioned cabinet and may be convenient in certain operating environments. The electronic components of the processing unit 180 are then arranged within the internal volume V110 of the housing 110, thus being effectively protected there by the housing 110. The electronic components of the processing unit 180 are advantageously housed in compartment V110.1, where they benefit from the sealing of this compartment and where they are in the immediate vicinity of the printed circuit board 150 to which they are directly connected electrically, in particular for the purposes of transmitting the position signal emitted by the position sensor(s) 151 and 152, without the corresponding electrical connection having to extend outside the housing 110.

Regardless of the design of the processing unit 180, that unit is connected to an electrical power source 70 which, as shown schematically by the dashed lines in FIG. 3, ensures the electrical supply of the processing unit 180, as well as that of the position sensor(s) 151 and 152, in particular via the processing unit 180 and the printed circuit board 150, and via the electrical connection between the latter, such as the electrical cable 190. In practice, the electrical power source 70 may be specific to the anchoring device 100, or it may be integrated into the lifting platform 1 for the purpose of supplying power to various components of the latter, such as the control panel 23 to which the processing unit 180 is electrically connected in such a case, for example.

Before describing the various processing steps implemented by the processing unit 180, it should be noted that, optionally, that unit is, as illustrated schematically in FIG. 3, advantageously connected to:
warning means 81, such as an audible and/or light-up alarm, which are activated by the processing unit 180 as a function of the result of the processing carried out by this processing unit, and/or
a wireless communication module 82 that sends data resulting from the processing performed by the processing unit 180 to a remote processing system.

The warning means 81 are designed to emit warning signals, in particular sound, voice and/or light signals, to the operator on board the platform 20 and/or to personnel in the vicinity of the aerial bucket 1. In practice, the warning means 81 may be dissociated from both the housing 110 and the cabinet of the processing unit 180, as illustrated schematically in FIG. 3, or may be carried by the aforementioned cabinet, or may be integrated into the housing 110, particularly when the processing unit 180 is totally integrated into the housing 110.

In turn, the wireless communication module 82 is designed to transmit said data via a wireless communication protocol capable of reaching said remote processing system, the latter being for example a monitoring centre, server(s), cloud hardware, etc. Again, the wireless communication module 82 may, in practice, be dissociated from both the housing 110 and the cabinet of the processing unit 180, as schematically illustrated in FIG. 3, or may be carried by the aforementioned cabinet, or may be integrated into the housing 110, particularly when the processing unit 180 is totally integrated into the housing 110.

The processing unit 180 is adapted to perform a first processing step of determining, from the position signal, whether the linkage member 120 is in the retracted or extended configuration. In other words, from the position signal emitted by the position sensor(s) 151 and 152, the processing unit 180 is able to determine whether the linkage member 120 is in the retracted configuration or whether the linkage member 120 is in the extended configuration. In this way, the processing unit 180, when activated, makes it possible to verify that the operator on board the platform 20 is attached to the platform via the anchoring device 100. In particular, if this first processing step implemented by the processing unit 180 results in the linkage member 120 being in the retracted configuration, the processing unit 180 concludes that there is a failure to anchor and can then advantageously activate the warning means 81 and/or have the wireless communication module 82 send a corresponding item of data to the aforementioned remote processing system.

The processing unit 180 is advantageously adapted to also implement a second processing step consisting of determining, from the position signal emitted by the position sensor(s) 151 and 152, whether the position occupied by the linkage member 120 in the extended configuration is between the aforementioned first and second functional positions, or between the aforementioned second functional position and dysfunctional position. Thus, the processing unit 180, when activated, makes it possible to verify that the operator on board the platform 20 has not fallen off that platform or been violently ejected from the platform 20. In particular, if this second processing step by the processing unit 180 results in the linkage member 120 being between the second functional position and the dysfunctional position, the processing unit 180 concludes that the operator has fallen from the platform 20 or has experienced a violent ejection force and may cause the warning means 81 and/or the wireless communication module 82 to emit a distress signal.

The processing unit 180 is advantageously adapted to also implement a third processing step consisting of processing, together with the position signal emitted by the position sensor(s) 151 and 152, a presence signal which is representative of the detection of the presence of an operator on the platform 20. This presence signal is symbolically depicted by the arrow 90 in FIG. 3. In practice, this presence signal 90 is emitted by a presence detector, which is separate from the anchoring device 100 and whose embodiment is not limiting. It is understood that this presence signal 90 informs the processing unit 180 of the actual presence of an operator on board the platform 20: the third processing step thus advantageously provides that, in the absence of an operator on the platform 20, as indicated by the presence signal 90, the processing unit 180 does not conclude that there is an anchoring fault when the linkage member 120 is in the retracted configuration.

According to a particularly practical and efficient embodiment, the presence signal 90 is a dead man's signal, i.e. a signal provided by a dead man's equipment with which the platform 20 is equipped, such as a dead man's trigger or a dead man's pedal: in a manner known per se, this dead man's equipment comprises a normally open switch which must be closed to allow the operation of all or part of the aerial bucket from the platform 20, in particular the activation of the control panel 23. In the example shown in FIG. 2, this dead man's equipment is a dead man's pedal 24. Thus, it is understood that once the operator is on board the platform 20 and needs to use the control panel 23, the operator must press the dead man's equipment, such as the dead man's pedal 24, which informs the processing unit 180 of the actual presence of the operator on board the platform 20, via the presence signal 90. Furthermore, in addition to ensuring the transmission of the presence signal 90, a wired link between the dead man's pedal 24 and the processing unit 180 advantageously allows that unit to be supplied with electricity from the dead man's pedal 24.

Advantageously, the processing unit 180 is also adapted to perform a fourth processing step of determining that the linkage member 120 is not in an extended configuration without its fastener 122 being hooked to the lanyard 40 attached to a non-inanimate operator. This fourth processing step is implemented by the processing unit 180 from a motion signal 91 which is schematically indicated by a dotted line in FIG. 3. This motion signal 91 is emitted by an inertial sensor 153 of the anchoring device 100. This inertial sensor detects movements in the space of the housing 110, in particular vibrations of the housing 110, and is for example carried by the printed circuit board 150. In practice, the embodiment of the inertial sensor 153 is not limiting; for example, the inertial sensor 153 is an accelerometer, in particular a six-axis accelerometer. In any embodiment of the inertial sensor 153, the motion signal 91 emitted by the inertial sensor is representative of the motions detected by the inertial sensor. Furthermore, the processing unit 180 is connected to this inertial sensor 153 so as to be able to process the motion signal 91, the corresponding transmission of the motion signal being ensured either by the electrical cable 190 as schematically illustrated in FIG. 3, or by a direct electrical connection when the processing unit 180 is totally integrated inside the housing 110. The fourth processing step mentioned above is based on the ability of the processing unit 180 to exploit, by means of ad hoc calculations, the motion signal 91 in order to conclude that the housing 110 is connected, via the linkage member 120, to an active, i.e. non-inanimate person. In particular, the processing unit 180 is able to conclude from the motion signal 91 that the housing 110 is “too” stationary to be connected to a non-inanimate person, which may be the case both when the operator on board the platform 20 is inanimate, and when the operator on the platform 20 is trying to “fool” the anchoring device 100 by hooking the fastener 122 to a false end or contrivance substituting for the lanyard 40, for example a piece of wood wedged across the fastener 122 to securely hold the linkage member 120 in the extended configuration. It is understood that, once the processing unit 180 concludes that the housing 110 is substantially immobile in space while the linkage member 120 is in the extended configuration, the processing unit 180 deduces that the operator on board the platform 20 is inanimate or is attempting to “fool” the anchoring device 100; similarly to the first processing step described above, the processing unit 180 may then activate the warning means 81 and/or notify the remote processing system via the wireless communication module 82. In practice, the processing unit 180 implements this fourth processing either exclusively on the basis of the motion signal 91, or on the basis of two differentiated motion signals, namely the motion signal 91 and another motion signal, issued by an inertial sensor which is distinct from the inertial sensor 153 and which is fixedly attached to the platform 20, for example by being integrated into the cabinet of the processing unit 180 when that unit is separated from the housing 110.

It should be noted that, for at least one or each of the four processing steps described above, the warning signals emitted by the warning means 81 may be modulated in timing, rhythm and/or intensity, specifically between the different processing steps where appropriate. For example, with regard to the warning signals emitted during the first processing step, these warning signals are first triggered according to a first level, in which an audible beep and/or a flashing light is emitted every second for ten seconds, then continue according to a second level, in which an audible beep and/or a flashing light is emitted every 0.5 seconds for ten seconds, and then continue according to a third level, in which an audible beep, stronger than the audible beeps of the first and second levels, and/or flashes of light, stronger than the flashing lights of the first and second levels, are emitted continuously, as long as the linkage member 120 is in the retracted configuration while the processing unit 180 is activated. Of course, the values of number, duration and intensity, which have been given above, are not limiting, but purely illustrative.

FIGS. 9 to 14 show an alternative embodiment of the anchoring device 100, which is referenced as 200.

The anchoring device 200 comprises a housing 210 which is functionally similar to the housing 110 of the anchoring device 100. In the embodiment considered in FIGS. 9 to 14, the housing 210 includes two half-shells 211 and 212, which are functionally similar to the main shell 111 and the cover 112 of the housing 110 and which are notably fixedly attached to each other.

Following similar considerations to those detailed above for the fastening means 113, the housing 210 is provided with a fastening means 213 which comprises a through-hole 214, which is functionally similar to the through-hole 114 and which is in particular able to receive the aforementioned locking ring 60, as illustrated in FIGS. 9 to 14.

The housing 210 forms an internal volume V210, here jointly delimited by the half-shells 211 and 212. The internal volume V210 is functionally similar to the internal volume V110 of the housing 110 and advantageously includes compartments V210.1 and V210.2, which are functionally similar to the compartments V110.1 and V110.2 and which are connected to each other by a passage 215 functionally similar to the passage 115.

The anchoring device 200 also comprises a linkage member 220, which is functionally similar to the linkage member 120 and which is here mounted on the housing 210 so as to be movable along a direction of movement X220, in particular translational along a geometric axis which corresponds to the direction of movement X220.

The linkage member 220 comprises an elongated body 221, which is functionally similar to the elongated body 121 and which is here arranged within the internal volume V210, extending both into the compartment V210.1, in the compartment V210.2 and in the passage 215 in which the elongated body 221 is advantageously received in a complementary manner so as to guide the linkage member 220 in a movable manner along the movement direction X220. To this end, the passage 215 is advantageously delimited, here in part, by a guide washer 218 fixedly attached to the housing 210.

In any embodiment, the linkage member 220 comprises a fastener 222 which is functionally similar to the fastener 122 of the anchoring device 100. In the embodiment illustrated in FIGS. 9 to 14, the fastener 222 is carried by one of the two opposite longitudinal ends of the elongated body 221 and comprises a ring whose internal opening forms a hooking zone for the end 42 of the lanyard 40, in particular for the carabiner 44, as illustrated in FIGS. 12 to 14. In practice, the aforementioned ring of the fastener 222 is mounted on the elongated body 221 either in a fixed manner or in a freely rotatable manner about a geometric axis corresponding to the direction of movement X220.

In any case, the linkage member 220 is designed to switch reversibly between retracted and extended configurations, which are functionally similar to the retracted and extended configurations respectively defined above for the linkage member 120 of the anchoring device 100. The linkage member 220 is thus in a retracted configuration in FIGS. 9 to 11, where the fastener 222 is advantageously housed in the compartment V210.2, being completely covered by walls 216 and 217 of the housing 210, which belong to the half-shells 211 and 212 respectively. The linkage member 220 is in the extended configuration in FIGS. 12 to 14, which illustrate three different respective positions of the linkage member 220 in the extended configuration and in which the fastener 222 is hooked to the lanyard 40, in particular to the carabiner 44 of the end 42 of that lanyard 40.

The anchoring device 200 also comprises a resilient member 230 which is functionally or even structurally similar to the resilient member 130 of the anchoring device 100. In the example illustrated in the Figures, the resilient member 230 is arranged around the elongated body 221, being centred on a geometric axis corresponding to the direction of movement X220, and is interposed, along the direction of movement X220, between the housing 210, in this case the guide washer 218, and the linkage member 220, in this case with the interposition of a sleeve 224 attached to the elongated body 221, so that the resilient member 230 is compressed when the linkage member 220 is moved from the retracted configuration to the extended configuration, as can be seen by comparing FIG. 10 with FIGS. 12 to 14. Here, the elastic member 230 comprises or consists of a spring which abuts against the guide washer 218 and against the sleeve 224.

The linkage member 220 is advantageously provided with a gripping element 223 which is functionally or even structurally similar to the gripping element 123, this gripping element 223 being visible in FIGS. 9 and 10, but not being shown in FIGS. 12 to 14.

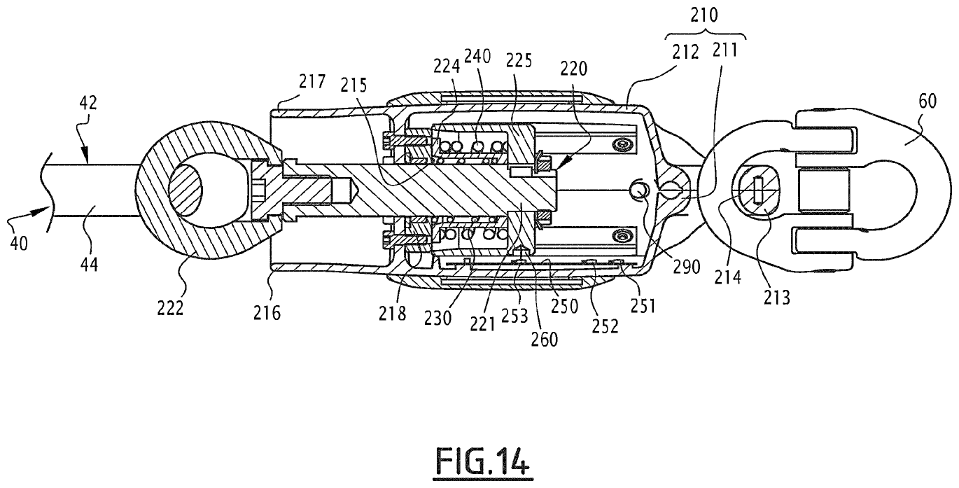

Unlike the linkage member 120, the linkage member 220 is carried directly by the housing 210, but with the advantageous integration of an overtravel spring 240 which makes it possible, outside a situation where the operator falls, to limit the travel of the linkage member 220 relative to the housing 210 in the direction of travel X220 to the distance between first and second functional positions which are respectively similar to those defined above for the linkage member 120, while allowing, when the operator falls off, the linkage member 220 to travel over a distance relative to the housing 210, beyond the second functional position, until the linkage member 220 reaches a dysfunctional position, which is similar to that defined above for the linkage member 120 and in which the linkage member 220 abuts against the housing 210 and is thus retained thereby. More precisely, the overtravel spring 240 is interposed, along the direction of movement X220, between the linkage member 220, here with the interposition of a sleeve 225 fixedly attached to the elongate body 221, and a stop mounted on the linkage member 220 so as to be movable in the direction of movement X220, this stop being formed here by the aforementioned sleeve 224 on which the resilient member 230 acts. As long as the overtravel spring 240 is not compressed, it kinematically binds the linkage member 220 and the aforementioned stop, formed here by the sleeve 224. Thus, without compression of the overtravel spring 240, the linkage member 220 can be moved relative to the housing 210 in the direction of movement X220 between two extreme positions which are opposite each other, namely the aforementioned first functional position, which is illustrated in FIGS. 9 to 11 and which is occupied by the linkage member 220 in the retracted configuration, and the aforementioned second functional position, which is illustrated in FIG. 13 and which is occupied by the linkage member 220 in extended configuration. In the second functional position, the aforementioned stop, formed here by the sleeve 224, is pressed against the housing 210, here against the guide washer 218. In FIG. 12, the linkage member 220 in the extended configuration occupies an intermediate position between the first and second functional positions. By compressing the overtravel spring 240 and thereby resiliently deforming it in the direction of movement X220, the linkage member 220 in the extended configuration can be moved relative to the housing 210 in the direction of movement X220 between the second functional position and the aforementioned dysfunctional position, illustrated in FIG. 14, which is further away from the first functional position than the second functional position and in which the sleeve 225 is here brought into abutment along the direction of movement X220 against the housing 210, here against the guide washer 218. The overtravel spring 240 is adapted to be compressed when the linkage member 220 in the second functional position is urged towards the dysfunctional position with a force greater than a predetermined threshold, the value of which is selected according to considerations similar to those detailed above for the force threshold relating to the mechanism 140 of the anchoring device 100.

In practice, it is understood that, in the embodiment considered in FIGS. 9 to 14 where the resilient member 230 acts on the sleeve 224 forming the aforementioned stop, the overtravel spring 240 is much stiffer than the spring belonging to or constituting the resilient member 230. Of course, other arrangements than the one detailed above are possible for the overtravel spring 240 and its associated stop, within the anchoring device 200.

Compared to the mechanism 140 of the anchoring device 100, the overtravel spring 240 and its associated stop thus enable the same overtravel function to be performed for the linkage member 220 when an operator, attached to the platform 20 via the lanyard 40 and the attachment device 200, falls off the platform 20 or is subjected to a powerful ejection force out from the platform 20. Unlike the mechanism 140, the actuation of the overtravel spring 240 is reversible and therefore does not damage the overtravel spring or its associated stop.

In the embodiment shown in FIGS. 9 to 14, the fact that the linkage member 220 is carried directly by the housing 210 is used to enhance the guidance of the linkage member 220 relative to the housing 210 along the direction of movement X220. Here, as is clearly visible in FIG. 11, it is thus provided that the sleeve 225 integral with the elongated body 221 cooperates by guided contact with dedicated arrangements of the housing 210, such as tracks 219 of the housing 210, which each extend in the direction of movement X220, being distributed around this movement axis, and on which the sleeve 225 slides while being centred on the movement axis X220.

In any case, the anchoring device 200 further comprises one or more position sensors that are functionally or even structurally similar to the position sensors 151 and 152 of the anchoring device 100. Thus, following similar considerations to those detailed above for the anchoring device 100, two such position sensors may be provided, similar to sensors 151 and 152 respectively. In the embodiment considered in FIGS. 9 to 14, the anchoring device 200 comprises three position sensors, respectively referenced as 251, 252 and 253. Here, the position sensors 251, 252 and 253 are carried on the same printed circuit board 250, functionally similar to the printed circuit board 150, and are, for example, Hall effect sensors that measure the variation of the magnetic field generated by a permanent magnet 260 that is fixedly carried by the linkage member 220. As can be seen from a comparison between FIGS. 10 and 12 to 14, when the linkage member 220 moves in the direction of movement X220 relative to the housing 210, in particular between the aforementioned first functional position and dysfunctional position, the magnet 260 scans the position sensors 251, 252 and 253 from a distance. The position of the magnet 260 is advantageously detected more specifically by the position sensor 251 when the linkage member 220 is in the first functional position as is clearly visible in FIG. 10, by the position sensor 252 when the linkage member 220 is between the first and second functional positions as is clearly visible in FIGS. 12 and 13, and by the position sensor 253 when the linkage member 220 is in the dysfunctional position as is clearly visible in FIG. 14.

Regardless of the design of the position sensor(s) of the anchoring device 200, such as the position sensors 251, 252 and 253, such position sensor(s) is/are advantageously arranged inside the internal volume V210 of the housing 210, in particular by being housed in the compartment V210.1

The anchoring device 200 further comprises a processing unit 280 which is functionally or even structurally similar to the processing unit 180, as schematically shown only in FIG. 9. In particular, following considerations similar to those detailed above in relation to the processing unit 180, the processing unit 280 can either be dissociated from the housing 210 by means of their connection via an electrical cable 290 similar to the cable 190, as illustrated schematically in FIG. 9, or integrated into the housing 210. In addition, similarly to the processing unit 180, the processing unit 280 is connected to the electrical power source 70, the warning means 81 and the wireless communication module 82. In particular, the processing unit 280 is adapted to carry out the various processing steps detailed above for the processing unit 180, this aspect of the use of the anchoring device 200 being identical to that of the anchoring device 100.

Finally, there are a number of possible developments and variants to what has been described so far. By way of example, the following is a list of various corresponding aspects, which may be considered in isolation with the above or in combination with each other:
rather than the linkage member 120 or 220 being translationally movable relative to the housing 110 or 210, other kinematics of relative movement between the linkage member and the housing are possible. For example, the linkage member may be provided so as to be pivotable relative to the housing about a pivot axis, the aforementioned direction of movement being peripheral to this pivot axis in such a case. Another example is based on kinematics combining translation and rotation. Of course, the position sensor(s) are adapted accordingly.
Optionally, the processing unit 180 or 280 is advantageously equipped with an external electrical connection port, such as a USB port. Such an external port makes it possible, among other things, to collect data stored in the processing unit, to update the processing steps performed by the processing unit, to configure operating parameters of the processing unit, and/or to activate/deactivate processing steps performed by the processing unit. For example, it is possible to configure the sound and/or visual levels of the warning signals.
Optionally, a back-up battery may be carried, advantageously in a removable manner, within the anchoring device 100 or 200, in particular inside the internal volume V110 or V210 of the housing 110 or 210 and/or in the cabinet of the processing unit 180 or 280 when that unit is dissociated from the housing 110 or 210, in order to temporarily maintain the operation of the position sensor(s) 151 and 152 or 251, 252 and 253 and of the processing unit 180 or 280 in the event that the power supply from the electrical power source 70 is interrupted.
When the platform 20 is likely to host several operators on board simultaneously, a first possibility consists of providing the anchoring device 100 or 200 only once, by assigning it to a reference operator and providing conventional anchoring elements on board the platform for the other operator(s); in this case, the reference operator is responsible for ensuring that the other operator(s) is/are properly anchored to the platform 20. A second possibility is to provide as many copies of the anchoring device 100 or 200 on board the platform 20 as there are operators likely to be present on the platform 20. In this case, one of the operators, known as the reference operator, must first declare the number of people actually present on board the platform 20 to a supervision system common to the respective processing units 180 or 280 of the various anchoring devices 100 or 200. This supervision system manages the data resulting from the processing respectively implemented by the different processing units 180 or 280, taking into account the declared number of operators respectively associated with the different anchoring devices.
Optionally, the data resulting from the processing carried out by the processing unit 180 or 280 is displayed on a screen so as to give corresponding visual information to the operator on board the platform 20, this screen potentially being integrated into the control panel 23 or being independent thereof.
As detailed above, the anchoring device 100 or 200 makes it possible, on the basis of the result of the processing steps implemented by its processing unit 180, to generate warning or distress signals, as well as corresponding data sent to a remote processing system, if necessary in the form of a device whose detection, processing, alerting and data-sending functions are integrated into a single unit. In any case, it is understood that the anchoring device 100 or 200 is thus completely independent of the control system of the aerial bucket 1 and is therefore adaptable to any type of aerial bucket, i.e. a machine for lifting people. This being said, optionally, the processing unit 180 or 280 of the anchoring device 100 or 200 may be connected, for example via a CAN bus, to the control system of the aerial bucket 1 so that the signals resulting from the processing steps carried out by the processing unit 180 or 280 are directly taken into account by the aforementioned control system and thus induce, if necessary, a limitation of the movements of the aerial bucket 1, or even the total stoppage of this aerial bucket.
Rather than the anchoring device 100 or 200 being used to anchor an operator to the platform of an aerial bucket, the anchoring device 100 or 200 is usable to anchor an operator to any type of height work structure, such as a scaffold, etc.

1. A device for anchoring an operator to a height work structure, such as a platform of an aerial bucket, the anchoring device comprising:
a housing, which forms an internal volume and which is provided with fastening means for fastening the housing to the height work structure,
a linkage member, provided with a fastener adapted to be hooked by a lanyard attachable to the operator, the linkage member being mounted on the housing so as to be movable along a direction of movement so as to be able to switch between:
a retracted configuration in which the fastener is at least partially arranged within the internal volume so that the housing renders the fastener inaccessible to prevent it being hooked by the lanyard, and
an extended configuration in which the fastener is at least partially arranged outside the internal volume so that the housing leaves the fastener accessible to be hooked by the lanyard and, once the fastener is hooked by the lanyard, the housing interferes with the lanyard to prevent the linking member from returning to the retracted configuration, and
at least one position sensor, which is arranged within the internal volume and which detects the position of the linkage member relative to the housing in the direction of movement.

2. The anchoring device according to claim 1, wherein the housing includes at least one wall which completely covers the fastener when the linkage member is in a retracted configuration.

3. The anchoring device according to claim 1, wherein the internal volume includes a first compartment, in which said at least one position sensor is housed, and a second compartment, in which the fastener is housed when the linkage member is in a retracted configuration,
wherein the housing closes the first compartment completely, except for a passage which connects the first and second compartments to one another and by means of which the linkage member is guided to move in the direction of movement, and
wherein the housing partially closes the second compartment, protecting the fastener when the linkage member is in the retracted configuration, while leaving the fastener free to be extracted from the second compartment when the linkage member has moved from the retracted to the extended configuration.

4. The anchoring device according to claim 1, wherein the linkage member is translationally movable with respect to the housing along an axis corresponding to the direction of movement.

5. The anchoring device according to claim 1, wherein the anchoring device further comprises a resilient member which acts on the linkage member so as to bias the linkage member from the extended configuration to the retracted configuration.

6. The anchoring device according to claim 1, wherein the linkage member is provided with a gripping clement which emerges outside the internal volume when the linkage member is in a retracted configuration.

7. The anchoring device according to claim 1, wherein the anchoring device further comprises a mechanism which releasably connects the linkage member and the housing such that:
in an unbroken state of the mechanism, the linkage member is movable relative to the housing in the direction of movement between two extreme positions which are opposite each other, namely a first functional position, which is occupied by the linkage member in a retracted configuration, and a second functional position, which is occupied by the linkage member in an extended configuration, and
in a broken state of the mechanism, the linkage member in the extended configuration is movable relative to the housing in the direction of movement between the second functional position and a dysfunctional position that is further from the first functional position than the second functional position,
which mechanism is adapted to move from the unbroken state to the broken state when the linkage member in the second functional position is urged towards the dysfunctional position with a force greater than a predetermined threshold.

8. The anchoring device according to claim 7, wherein the mechanism comprises a mechanical fuse, the breaking of which causes the mechanism to change from the unbroken state to the broken state, and a support, which is mounted the housing so as to be movable in the direction of movement and which carries the linkage member and is connected to the linkage member by the mechanical fuse such that:
in the unbroken state of the mechanism, the mechanical fuse kinematically connects the linkage member and the support to each other in the direction of movement between the first and second functional positions, the support being abutted against the housing in the direction of movement when the linkage member is in the second functional position, and
in the broken state of the mechanism, the linkage member is freely movable in the direction of movement relative to the support.

9. The anchoring device according to claim 1, wherein the anchoring device comprises an overtravel spring which is interposed along the direction of movement between the linkage member and a stop mounted on the linkage member movably along the direction of movement, such that:
when the overtravel spring is not compressed, the linkage member is movable relative to the housing in the direction of movement between two extreme positions which are opposite each other, namely a first functional position, which is occupied by the linkage member in the retracted configuration, and a second functional position, which is occupied by the linkage member in the extended configuration and in which the stop is pressed against the housing in the direction of movement, and
when the overtravel spring is compressed, the linkage member in the extended configuration is moveable relative to the housing in the direction of movement between the second functional position and a dysfunctional position which is further from the first functional position than the second functional position,
which overtravel spring is designed to be compressed when the linkage member in the second functional position is urged towards the dysfunctional position with a force above a predetermined threshold.

10. The anchoring device according to claim 1, wherein the anchoring device further comprises a processing unit which:
is connected to said at least one position sensor so as to be able to process a position signal, which is emitted by said at least one position sensor and which is representative of the position of the linkage member, detected by the position sensor, and
is adapted to determine from the position signal whether the linkage member is in the retracted or extended configuration.

11. The anchoring device according to claim 7, wherein the anchoring device further comprises a processing unit which:
is connected to said at least one position sensor so as to be able to process a position signal, which is emitted by said at least one position sensor and which is representative of the position of the linkage member, detected by the position sensor, and
is adapted to determine from the position signal whether the linkage member is in the retracted or extended configuration,
and wherein the processing unit (180; 280) is also adapted to, from the position signal, determine whether the position the linkage member (120; 220) occupies in the extended configuration is between the first and second functional positions, or between the second functional position and the dysfunctional position.

12. The anchoring device according to claim 10, wherein the processing unit is adapted to also process a presence signal, which is representative of the detection of the presence of an operator on the height work structure.

13. The anchoring device according to claim 10,
wherein the anchoring device further comprises an inertial sensor, which detects motions in the space of the housing and which emits a motion signal, representative of the motions detected by the inertial sensor, and wherein the processing unit is:
connected to the inertial sensor so that the motion signal can be processed, and
adapted to determine from the motion signal that the linking member is not in the extended configuration without the fastener hooked to the lanyard attached to a non-inanimate operator.

14. The anchoring device according to claim 10, wherein the anchoring device comprises warning means, such as an audible and/or light-up alarm, which are connected to the processing unit and which are activated by the processing unit depending on the result of the processing steps carried out by the processing unit.

15. The anchoring device according to claim 10, wherein the anchoring device comprises a wireless communication module, which is connected to the processing unit and which sends to a remote processing system data resulting from the processing steps implemented by the processing unit.

16. An aerial bucket, comprising:
a ground support chassis,
a platform adapted for at least one operator to stand on,
a lifting structure, which supports the platform and which is arranged on the frame so as to be able to move the platform at least in height relative to the frame, and
at least one anchoring device, which is in accordance with claim 1 and whose housing is attached to the platform by said fastening means.

17. The anchoring device according to claim 9, wherein the anchoring device further comprises a processing unit which:
is connected to said at least one position sensor so as to be able to process a position signal, which is emitted by said at least one position sensor and which is representative of the position of the linkage member, detected by the position sensor, and
is adapted to determine from the position signal whether the linkage member is in the retracted or extended configuration,
and wherein the processing unit is also adapted to, from the position signal, determine whether the position the linkage member occupies in the extended configuration is between the first and second functional positions, or between the second functional position and the dysfunctional position.
